(19) United States
(12) Patent Application Publication
(10) Pub. No.: US 2025/0328817 A1
(43) Pub. Date: Oct. 23, 2025

(54) INFORMATION PROCESSING APPARATUS, INFORMATION PROCESSING PROGRAM, AND INFORMATION PROCESSING METHOD

(71) Applicant: NIPPON TELEGRAPH AND TELEPHONE CORPORATION, Tokyo (JP)

(72) Inventors: Aki HAYASHI, Tokyo (JP); Yuki YOKOHATA, Tokyo (JP); Takahiro HATA, Tokyo (JP); Kohei MORI, Tokyo (JP); Masato KAMIYA, Tokyo (JP)

(73) Assignee: NIPPON TELEGRAPH AND TELEPHONE CORPORATION, Tokyo (JP)

(21) Appl. No.: 18/868,106

(22) PCT Filed: May 23, 2022
(86) PCT No.: PCT/JP2022/021156

§ 371 Date: Nov. 21, 2024

(51) Int. Cl. G06N 20/00

(52) U.S. Cl. CPC G06N 20/00

(57) ABSTRACT

An information processing apparatus classifies each congested section represented by training data including a start point position of congestion and an end point position of the congestion for each congestion direction, recursively repeats processing of connecting adjacent congested sections as a continuous integrated congested section for each congested section to determines which congested sections constitute the integrated congested section, classifies the integrated congested section according to determination divisions for each integrated congested section representing the same congestion, and sets an extension scale of the integrated congested section for each integrated congested section representing the same congestion and for each determination division.

### TECHNICAL FIELD

The present disclosure relates to an information processing apparatus, an information processing program, and an information processing method for predicting an extension length of congestion that suddenly occurs due to a demand change.

### BACKGROUND ART

There is known a congestion prediction service for predicting the location, time, and length of congestion and providing prediction information to users (for example, NPL 1). When a user inputs a date and time to a congestion prediction service, for example, a road map as shown in FIG. 19 is displayed on a screen, and a section where the occurrence of congestion is predicted at the input date and time is displayed on the road map by an arrow 50, for example.

Further, when the user selects a detailed icon 51 displayed with relation to the arrow 50, for example, a detailed congestion screen 52 as shown in FIG. 20 is displayed. On the detailed congestion screen 52, a congested section, a congestion occurrence time zone, a place that is a bottleneck of congestion, a congestion length at a peak, a time required to pass the congestion, and the like are displayed.

### Non Patent Literature 1

NEXCO EAST, ZENRIN DataCom, “Drive traffic” <URL: https://www.drivetraffic.jp/.>

### SUMMARY OF INVENTION

### Technical Problem

In such a congestion prediction service, the occurrence of traffic congestion is predicted on the basis of actual values of traffic volume increase occurring steadily (for example, one year or more) confirmed in the past. Therefore, with respect to congestion which has newly occurred due to changes in behavior patterns caused by the corona disaster, such as an increase in the number of times of use of drive-through or an increase in the demand for visits to DIY stores, for example, there is a problem that the number of actual values of traffic volume increase which can be used for prediction is limited.

Therefore, in the conventional congestion prediction service, when new congestion occurs in a place where congestion has not occurred steadily in accordance with a change in demand (hereinafter referred to as “sudden congestion”), it is difficult to predict how much congestion will extend in the future at the time when the congestion starts to occur.

On the other hand, it is also possible to acquire a state of sudden congestion from congestion images captured by cameras installed on a road, but it is impossible to predict where sudden congestion will occur in advance, and thus it is necessary to install cameras in various places, which leads to an increase in the congestion prediction cost. Furthermore, when a state of sudden congestion is acquired from a congestion image, the state after the occurrence of the congestion is inevitably acquired, and thus the method of acquiring the state of sudden congestion from the congestion image delays the time of providing information to the user compared with congestion prediction information for notifying of the possibility of the occurrence of congestion in advance. Therefore, it is desirable to predict the occurrence of sudden congestion from observation data (hereinafter referred to as “training data”) related to past sudden congestion without depending on congestion images. In the verification described in this specification, information acquired from the Japanese Road Traffic Information Center (JARTIC) is used as observation data related to sudden congestion.

An object of the present invention in view of the above circumstances is to provide an information processing apparatus, an information processing program, and an information processing method capable of predicting an extension length of sudden congestion even when sudden congestion for which training data that can be used for congestion prediction in conventional congestion prediction services has not been obtained has occurred.

### Solution to Problem

A first aspect of the present disclosure is an information processing apparatus including: a classification unit configured to classify each congested section represented by training data including a start point position of congestion and an end point position of the congestion for each congestion direction represented by the start point position and the end point position; a determination unit configured to recursively repeat processing of connecting adjacent congested sections in which the start point position and the end point position are within a predetermined range as a continuous integrated congested section until the start point position or the end point position of the adjacent congested sections disappears within the predetermined range, for each congested section classified by the classification unit for each congestion direction, to determine which congested sections constitute the integrated congested section; and a setting unit configured to acquire the integrated congested section determined by the determination unit for each integrated congested section indicating the same congestion, classify, for each integrated congested section indicating the same congestion, the integrated congested section according to each determination division into which a congestion occurrence time is classified for each day of the week, each working attribute indicating whether a congestion occurrence time is a weekday or a holiday, and each time zone, and set an extension scale of the integrated congested sections for each integrated congested section indicating the same congestion and for each determination division.

A second aspect of the present disclosure is an information processing apparatus including: a selection unit configured to identify whether or not there is a deviation in an extension scale of a designated congested section for each determination division using an extension scale for each congested section obtained from an extension length for each of continuous identical congested sections for which an occurrence time has been classified into each determination division for each day of the week, each working attribute indicating whether a congestion occurrence time is a weekday or a holiday, each time zone, and for each determination division, and when there is a deviation in the extension scale of the designated congested section within the determination divisions, select the determination division to be used to predict an extension length of a congested section according to a combination of the determination divisions where there is a deviation in the extension scale; and a prediction unit configured to predict an extension length of the designated congested section at a designated date and time using the extension length of the designated congested section included in the determination division selected by the selection unit.

A third aspect of the present disclosure is an information processing program causing a computer to function as each unit of the information processing apparatus.

A fourth aspect of the present disclosure is an information processing method in an information processing apparatus including a classification unit, a determination unit, a setting unit, a selection unit, and a prediction unit, the information processing method including: a classification step in which the classification unit classifies each congested section represented by training data including a start point position of congestion and an end point position of the congestion for each congestion direction represented by the start point position and the end point position; a determination step in which the determination unit recursively repeats processing of connecting adjacent congested sections in which the start point position and the end point position are within a predetermined range as a continuous integrated congested section until the start point position or the end point position of the adjacent congested sections disappears within the predetermined range, for each congested section classified for each congestion direction, to determine which congested sections constitute the integrated congested section; a setting step in which the setting unit classifies, for each integrated congested section indicating the same congestion, the integrated congested section according to each determination division into which a congestion occurrence time is classified for each day of the week, each working attribute indicating whether a congestion occurrence time is a weekday or a holiday, and each time zone, and sets an extension scale of the integrated congested section for each integrated congested section indicating the same congestion and for each determination division; a selection step in which the selection unit identifies whether or not there is a deviation in an extension scale of a designated congested section within the determination divisions using the extension scale, and when there is a deviation in the extension scale of the designated congested section within the determination divisions, selects the determination division to be used to predict an extension length of a congested section according to a combination of the determination divisions where there is a deviation in the extension scale; and a prediction step in which the prediction unit predicts an extension length of the designated congested section at a designated date and time using the extension length of the designated congested section included in the selected determination division.

### Advantageous Effects of Invention

According to the information processing apparatus, the information processing program, and the information processing method of the present disclosure, it is possible to obtain an effect of predicting an extension length of sudden congestion even when sudden congestion for which training data that can be used for congestion prediction in conventional congestion prediction services has not been obtained has occurred.

### BRIEF DESCRIPTION OF DRAWINGS

FIG. 1 is a diagram showing an example of a functional configuration of an information processing apparatus.

FIG. 2 is a diagram showing an example of a congested section.

FIG. 3 is a diagram showing an example of a process of connecting congested sections.

FIG. 4 is a diagram showing an example of a branched congested section.

FIG. 5 is a diagram showing an example of a day-of-the-week time zone division table.

FIG. 6 is a diagram showing an example of a working time zone division table.

FIG. 7 is a diagram showing an example of an extension scale determination table.

FIG. 8 is a diagram showing an example of a configuration of main parts of an electrical system of a computer.

FIG. 9 is a flowchart showing an example of a flow of prediction processing.

FIG. 10 is a flowchart showing an example of a flow of congested section determination processing.

FIG. 11 is a flowchart showing an example of a flow of extension length prediction processing.

FIG. 12 is a diagram showing an example of deviation of an extension tendency of congested sections classified for each congestion direction.

FIG. 13 is a diagram showing an example of RMSE for each combination of determination divisions in a case in which a use ratio of training data has been changed.

FIG. 14 is a diagram showing an example of analysis on a congested section having the lowest extension length prediction accuracy.

FIG. 15 is a diagram showing an example of analysis on a congested section having the highest extension length prediction accuracy.

FIG. 16 is a diagram showing an example of analysis on a congested section in which an extension length is not “0” but the extension length prediction accuracy is relatively high.

FIG. 17 is a diagram showing an example of a congested section in an area where roads are complicated.

FIG. 18 is a diagram showing an example of RMSE for each combination of determination sections in a case in which a use ratio of training data has been changed in an area where roads are complicated.

FIG. 19 is a diagram showing an example of congestion display in an existing congestion prediction service.

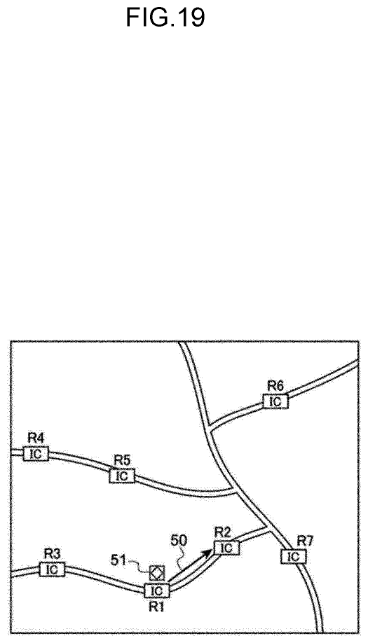

FIG. 20 is a diagram showing an example of a detailed congestion screen in the existing congestion prediction service.

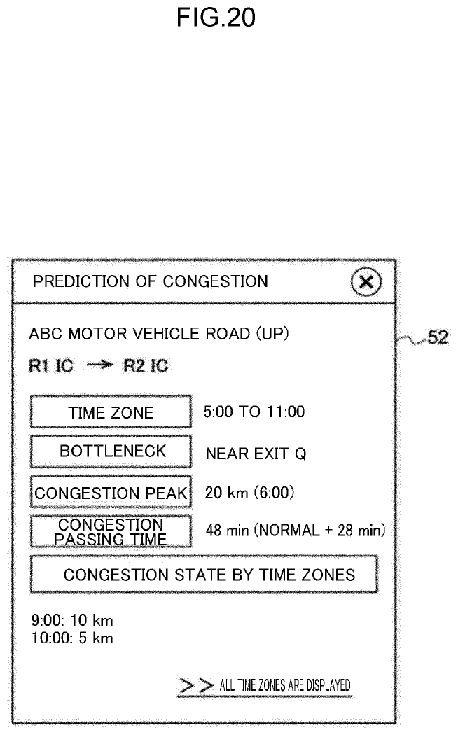

### DESCRIPTION OF EMBODIMENTS

Hereinafter, the present embodiment will be described with reference to the drawings. The same components and the same processing are denoted by the same reference signs throughout the drawings, and overlapping description is omitted.

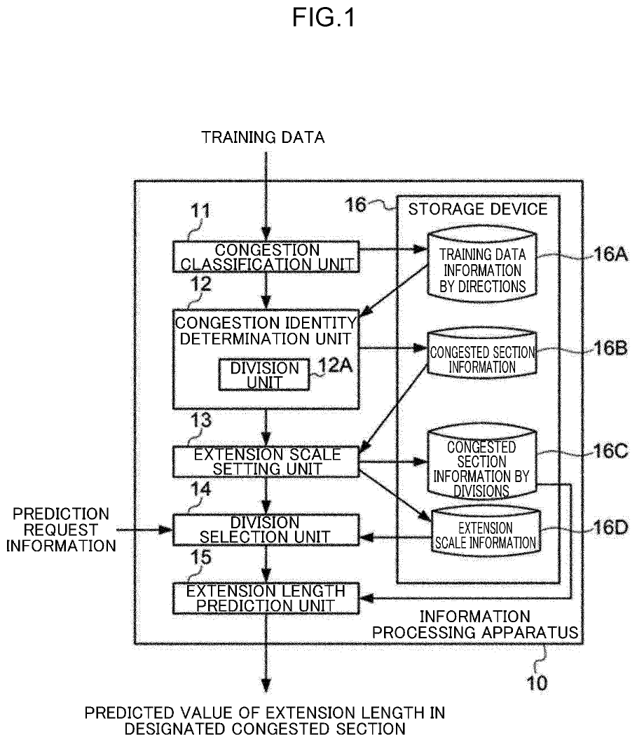

FIG. 1 is a diagram showing an example of a functional configuration of an information processing apparatus 10 according to the present disclosure. The information processing apparatus 10 is an apparatus for predicting an extension length of a future congested section 3 from past congestion information recorded in chronological order.

Congestion information is information in which the occurrence state of each instance of congestion occurring at that point in time at a predetermined interval, such as every 5 minutes, for example, has been recorded in chronological order over a predetermined period of time. Congestion information corresponding to each instance of congestion includes at least time-series information representing a time series of congestion information such as the date and time when the occurrence state of congestion has been recorded, a congestion start point position, and a congestion end point position. In other words, information in which a congestion occurrence state has been recorded also includes other information such as a congestion length, for example, but congestion information in the present embodiment may include time-series information, a congestion start point position, and a congestion end point position.

Congestion information recorded at the same date and time includes the same time series information. A start point position and an end point position of congestion are represented by two-dimensional coordinate values using latitude and longitude, for example.

Since the information processing apparatus 10 predicts an extension length of a future congested section 3 using such congestion information, each piece of congestion information in chronological order is referred to as “training data” hereinafter.

The extended length of the congested section 3 in the present embodiment is an absolute value of increase/decrease between a congestion length of the congested section 3 represented by specific training data and a congestion length of the congested section 3 represented by training data immediately before and adjacent to the training data in chronological order and recorded at the same congestion occurrence point. That is, if a training data recording interval is five minutes, the absolute value of an increase/decrease in a congestion length with respect to the congested section 3 five minutes before is referred to as an extension length of the congested section 3.

This information processing apparatus 10 includes functional units such as a congestion classification unit 11, a congestion identity determination unit 12, an extension scale setting unit 13, a division selection unit 14, an extension length prediction unit 15, and a storage device 16, as shown in FIG. 1.

The congestion classification unit 11 classifies each congested section 3 represented by training data for each congestion direction with reference to start point positions and end point positions of congestion included in the training data. That is, the congestion classification unit 11 is an example of a classification unit for classifying each piece of training data for each congestion direction.

Although there is no restriction on congestion directions to be classified, as an example in the present embodiment, congested sections 3 represented by training data are classified into four directions of a direction from the west to the east, a direction from the east to the west, a direction from the south to the north, and a direction from the north to the south. Therefore, a congested section 3 generated between the opposite lanes is classified into different directions, for example, a direction from the west to the east and a direction from the east to the west, as there are up and down even on the same road.

The congestion classification unit 11 stores training data classified for each congestion direction in the storage device 16 as training data information 16A by direction.

On the other hand, when congestion occurs intermittently, a congested section 3 forming one instance of congestion as a whole may be recognized as a plurality of finely divided congested sections 3. In such a case, it is preferable to handle each congested section 3 as a fragment of congested sections 3 constituting a continuous congested section 3 instead of handling each congested section 3 as an independent congested section 3.

Therefore, the congestion identity determination unit 12 acquires training data classified for each congestion direction from the training data information 16A by directions and determines which congested sections 3 correspond to a continuous congested section 3. A continuous congested section 3 represented by a plurality of congested sections 3 in this manner is called an “integrated congested section 5.” Hereinafter, the integrated congested section 5 is represented as a “congested section 5.” The congestion identity determination unit 12 for determining the range of the congested section 5 is an example of a determination unit.

The congestion identity determination unit 12 acquires training data classified for each congestion direction from the training data information 16A by direction and converts a start point position and an end point position of congestion included in each piece of training data into a geohash 1.

A geohash 1 is an example of a predetermined range, and is a divided region obtained by dividing each area on the earth on the basis of latitude and longitude. Each geohash 1 is represented by symbols of a plurality of different digits, and as the number of digits representing the geohash 1 increases, the range of the region represented by the geohash 1 becomes narrower and the accuracy of the geohash 1 becomes higher.

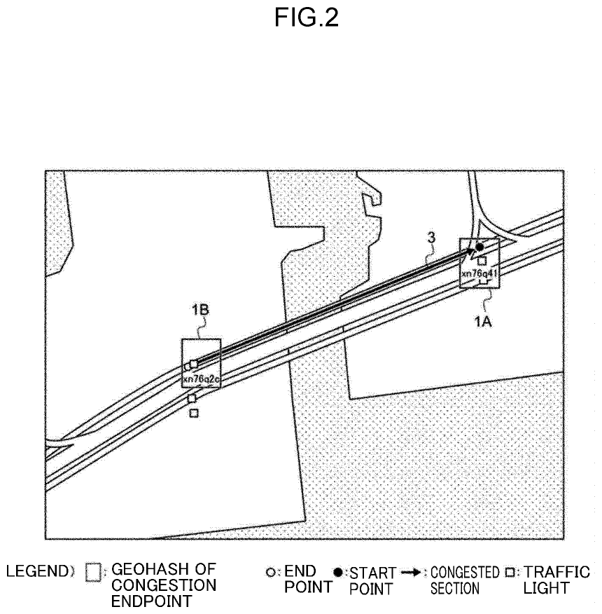

FIG. 2 is a diagram showing a display example in which a start point position and an end point position of congestion indicated by a congested section 3 are displayed on a map. The example of FIG. 2 shows that the end points of the congestion included in the training data, that is, the start point position and the end point position of the congestion, have been converted into a geohash 1A represented by a symbol of “xn76q41” and a geohash 1B represented by a symbol of “xn76q2c.” In a case in which each geohash 1 is separately described such as the geohash 1A and the geohash 1B, letters are added to the end of the geohash 1 for discrimination.

The congestion identity determination unit 12 selects training data for which it has not yet been determined whether or not the congested section 3 constitutes the congested section 5. The congestion identity determination unit 12 performs processing of connecting another congested section 3 having a geohash 1 (referred to as a “start point geohash 1”) corresponding to the start point position of the congested section 3 (referred to as a “selected congested section 3”) represented by the selected training data as a geohash 1 (referred to as an “end point geohash 1”) corresponding to the end point position of the congestion to the selected congested section 3. That is, the congestion identity determination unit 12 performs processing of connecting another congested section 3 having the start point geohash 1 of the selected congested section 3 as the end point geohash 1 to the selected congested section 3. Then, the congestion identity determination unit 12 recursively repeats processing of setting the connected congested sections 3 as a newly selected congested section 3 and connecting congested sections 3 until another congested section 3 having the start point geohash 1 of the selected congested section 3 as the end point geohash 1 disappears.

Further, the congestion identity determination unit 12 performs processing of setting the end point geohash 1 of the selected congested section 3 as a start point and connecting another congested section 3 having the end point geohash 1 of the selected congested section 3 as a start point geohash to the selected congested section 3. Then, the congestion identity determination unit 12 recursively repeats processing of setting the connected congested sections 3 as a newly selected congested section 3 and connecting congested sections 3 until another congested section 3 having the end point geohash 1 of the selected congested section 3 as the start point geohash 1 disappears.

The above processing is performed between pieces of training data classified into the same congestion direction to generate a congested section 5.

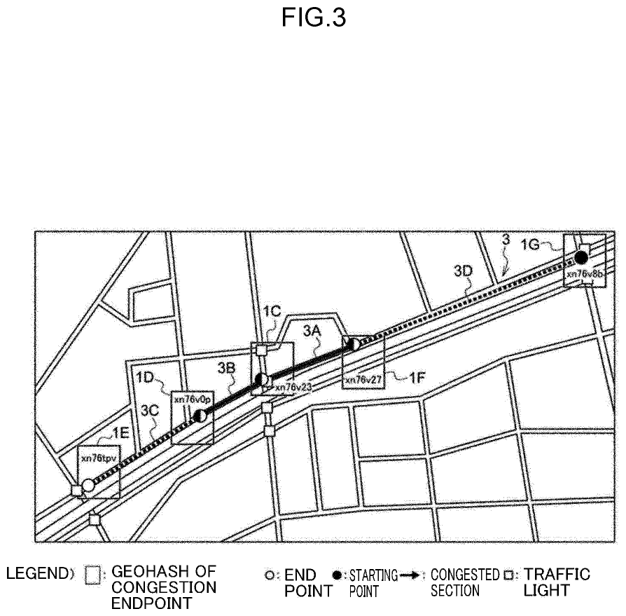

FIG. 3 is a diagram showing an example of processing of connecting congested sections 3 displayed on a map. The example of FIG. 3 shows a process of generating a congested section 5 having a geohash 1G represented by a symbol of “xn76v8b” as a start point geohash 1 and a geohash 1E represented by a symbol of “xn76tpv” as an end point geohash 1 by connecting a congested section 3B having a geohash 1C represented by a symbol of “xn76v23” that is the end geohash 1 of a congested section 3A as the start point geohash 1, a congested section 3C having a geohash 1D represented by a symbol of “xn76v0p” that is the end point geohash 1 of the congested section 3B as the start point geohash 1, and a congested section 3D having a geohash 1F represented by a symbol of “xn76v27” that is the start point geohash 1 of the congested section 3A as the end point geohash 1 for the congested section 3A.

FIG. 3 shows an example in which the start point position of congestion indicated by one of congested sections 3 to be connected and the end point position of congestion indicated by the other congested section 3 overlap. On the other hand, even if the start point position of the congestion indicated by one congested section 3 is separated from the end point position indicated by the other congested section 3, if the start point position and the end point position of each congested section are included in the same geohash 1, it is needless to say that adjacent congested sections 3 may be connected to each other. Further, even if the start point position of congestion indicated by a congested section 3 to be newly connected and the end point position of congestion indicated by the other congested section 3 are not included in the same geohash 1, the congested section 3 may be connected if the start point position is included in the geohash 1 of any congested section 3 which has been connected by being regarded as a continuous congested section 3 during the connection operation so far.

That is, the congestion identity determination unit 12 recursively repeats processing of connecting adjacent congested sections 3 in which the start point position and the end point position of congestion are within a predetermined range as a continuous congested section 3 until the start point positions or the end point positions of adjacent congested sections 3 disappear within the predetermined range, for each congested section 3 classified for each congestion direction, to determine which congested sections 3 represents continuous congestion.

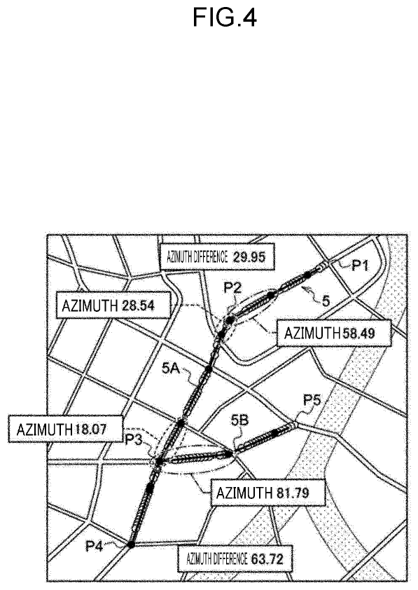

Meanwhile, FIG. 4 is a diagram showing an example of a congested section 5 displayed on a map. For example, in a city center where roads are crowded, the congested section 5 is not represented by one line and may be represented by a plurality of lines by branching at a point P3 corresponding to a branch point of a road, as shown in FIG. 4. The presence of a branch point on a road means that one road branched from the branch point is managed as a road different from the other road.

Therefore, it is preferable to handle the branched congested section 5 as a different congested section 5 with the branch point as a boundary.

Specifically, in the case of the congested section 5 shown in FIG. 4, it is preferable to handle the congested section 5 by dividing it into a congested section 5A connecting a point P1 and a point P4 and a congested section 5B connecting the point P3 and a point P5.

For this purpose, the congestion identity determination unit 12 shown in FIG. 1 includes a division unit 12A. The division unit 12A divides the congested section 5 using azimuths of adjacent congested sections 3 constituting the congested section 5. The azimuth of a congested section 3 is a value expressed by an angle representing the advancing direction of the congested section 3 when the north direction is set to 0 degrees, the east direction is set to 90 degrees, the south direction is set to 180 degrees, and the west direction is set to 270 degrees.

For each adjacent congested sections 3 constituting the congested section 5, the division unit 12A calculates a difference in the azimuths of the congested sections 3, that is, an azimuth difference. In a case in which the azimuth difference between the congested sections 3 is equal to or greater than a predetermined angle, the division unit 12A determines that the adjacent congested sections 3 are congested sections 3 constituting different congested sections 5, and divides the congested sections 5 at the connection point of the congested sections 3.

In the congested section 5 shown in FIG. 4, when the azimuth of one of congested sections 3 adjacent to each other at the point P2 is 28.54 degrees and the azimuth of the other congested section 3 is 58.49 degrees, the azimuth difference between the congested sections 3 is 29.95 degrees. Further, when the azimuth of one of congested sections 3 adjacent to each other at the point P3 is 18.07 degrees and the azimuth of the other congested section 3 is 81.79 degrees, the azimuth difference between the congested sections 3 is 63.72 degrees.

Therefore, if a threshold value of an azimuth difference between congested sections 3 is set to, for example, 40 degrees, it is ascertained that the congested sections 3 adjacent to each other at the point P2 constitute a continuous congested section 5, and the congested sections 3 adjacent to each other at the point P3 constitute a different congested section 5. In this manner, the division unit 12A divides the congested section 5 into the congested section 5A and the congested section 5B. The threshold value of the azimuth difference between congested sections 3 is an example and is set depending on road conditions.

That is, when the azimuth difference between adjacent congested sections 3 constituting the congested section 5 is equal to or greater than a predetermined angle, the division unit 12A divides the congested section 5 into two different congested sections 5 at a connection point of the adjacent congested sections 3 having an azimuth difference equal to or greater than the predetermined angle.

In this manner, the congestion identity determination unit 12 determines the range of congested sections 5 for training data classified for each congestion direction in association with the division unit 12A and calculates an extension length for each congested section 5 from changes in the congested sections 5 in chronological order. The extension length of the congested section 5 is represented by a predetermined unit, for example, in units of 10 m.

The congestion identity determination unit 12 executes the congested section 5 determined as described above for training data in each time series classified for each congestion direction. Then, the congestion identity determination unit 12 classifies congested sections 5 for each congested section 5 which can be regarded as the same congestion and stores information in which time-series information and an extension length have been associated with each congested section 5 in the storage device 16 as congested section information 16B. Whether or not congested sections are the same congested section can be determined by, for example, whether or not the congested sections are congested sections 5 connected with the same geohash 1 as a starting point. Hereinafter, a set of congested sections 5 connected with the same geohash 1 as a starting point is referred to as “identical congested sections 5.”

The extension scale setting unit 13 acquires a congested section 5 for each identical congested section 5 from the congested section information 16B.

The extension scale setting unit 13 classifies each congested section 5 into a predetermined determination division according to a congestion occurrence time for each identical congested section 5 in order to acquire an extension tendency in each congested section 5. The determination division is a division provided in order to determine whether or not a significant difference, that is, a deviation can be seen in the extension tendency of a congested section 5 belonging thereto, and is set in advance by a user, for example.

In the present embodiment, as an example, a congested section 5 is classified into each determination division of a day-of-the-week division, a working division, and a time zone division, but it may be classified into other determination divisions, for example, determination divisions such as days that are multiples of 5, such as the fifth and tenth days, and other days. Further, congested sections 5 may be classified into determination divisions for every month, every season of spring, summer, autumn, and winter, and every year. By classifying congested sections 5 for each season, it is easy to predict an extension length of a seasonal congested section 5 such as sudden congestion caused by flower visitors which starts to occur only in spring from two years before, for example.

The day-of-the-week division is a division for indicating on which of the seven days of the week from Sunday to Saturday each congested section 5 has occurred, and the time zone division is a division for indicating in which time zone of 24 time zones obtained by dividing one day into one hour intervals, each congested section 5 has occurred. Further, the working division is a division for indicating whether each congested section 5 occurs on a weekday or on a holiday.

Therefore, the extension scale setting unit 13 classifies each congested section 5 into any division of a day-of-the-week time zone division table 19A having 168 divisions for each identical congested section 5 using the day-of-the-week time zone division table 19A divided by combinations of a day-of-the-week division and a time zone division.

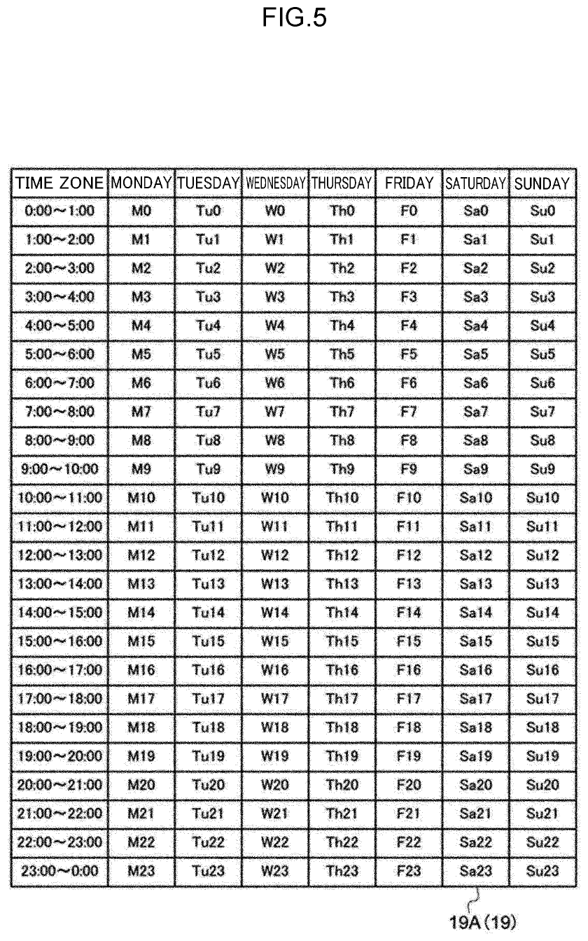

FIG. 5 is a diagram showing an example of the day-of-the-week time zone division table 19A. For example, if a congested section 5 occurs from 7:00 to 8:00 of the Friday, the congested section 5 is classified into a division represented by “F7.”

Referring to the day-of-the-week time zone division table 19A, a congested section 5 classified for each day-of-the-week division and for each time zone division is obtained. Although one day is divided into one-hour units in the day-of-the-week time zone division table 19A shown in FIG. 5, it is needless to say that one day may be divided into other units such as two-hour units.

Further, the extension scale setting unit 13 classifies each congested section 5 into any division of a working time zone division table 19B having 48 divisions for each identical congested section 5 using the working time zone division table 19B divided by combinations of the working division and the time zone division.

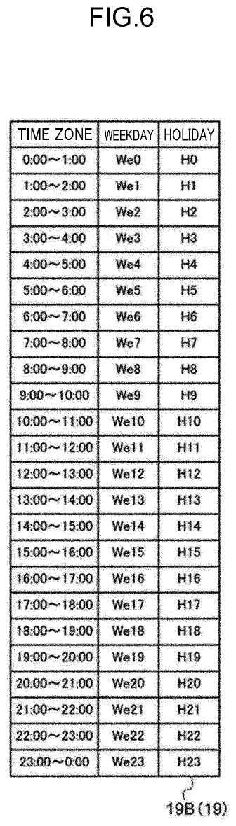

FIG. 6 is a diagram showing an example of the working time zone division table 19B. For example, if a congested section 5 occurs from 14:00 to 15:00 on a holiday, the congested section is classified into a division represented by “H14.” Although holidays are different depending on people, Saturday, Sunday, and congratulatory dates are defined as holidays and days other than holidays are defined as weekdays in the present embodiment.

Referring to the working time zone division table 19B, a congested section 5 classified for each time zone division and for each working division can be obtained. Since a congested section 5 classified for each time zone division can also be obtained from the day-of-the-week time zone division table 19A, it is not necessarily necessary to divide the working division by time zones, as shown in the working time zone division table 19B shown in FIG. 6, and the working division may be simply divided into two divisions of a weekday and a holiday.

In this manner, the extension scale setting unit 13 stores information obtained by classifying each congested section 5 into a determination division in the storage device 16 as congested section information 16C by divisions for each identical congested section 5. That is, the congested section information 16C by divisions is present for each identical congested section 5. For convenience of description, the day-of-the-week time zone division table 19A and the working time zone division table 19B may be collectively referred to as a “division table 19.”

Meanwhile, in each determination division, the extension scale setting unit 13 arranges extension lengths of congested sections 5 in ascending order or descending order for each congested section 5 with continuous time series among identical congested sections 5 and identifies the extension length positioned at the center of the arrangement, that is, the median of the extension lengths. A congested section 5 with continuous time series refers to a congested section 5 included in a range from the occurrence of congestion to disappearance of the congestion, and a congested section 5 with continuous time series is hereinafter referred to as a “continuous congested section 5.”

Then, the extension scale setting unit 13 calculates the entire section average of medians of extension lengths and the standard deviation of the medians of the extension lengths for each determination division, and generates an extension scale determination table 4 for each determination division. The extension scale determination table 4 is a table for determining an extension scale of a congested section 5 classified into the corresponding determination division.

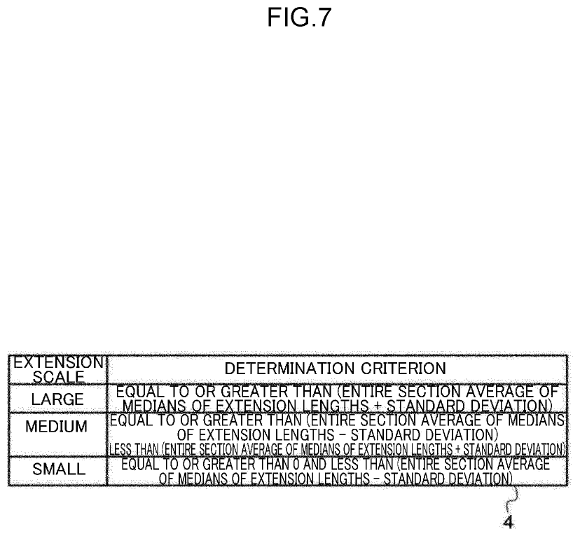

FIG. 7 is a diagram showing an example of the extension scale determination table 4. In the extension scale determination table 4, a determination criterion is defined for each extension scale. In the case of the example of the extension scale determination table 4 shown in FIG. 7, the extension scale is set to “large” if the extension length of a congested section 5 is equal to or greater than (entire section average of extension length medians+standard deviation), and the extension scale is set to “medium” if the extension length of the congested section 5 is equal to or greater than (entire section average of extension length medians−standard deviation) and less than (entire section average of extension length medians+standard deviation). Further, if the extension length of the congested section 5 is equal to or greater than 0 and less than (entire section average of extension length medians−standard deviation), the extension scale is set to “small.” In FIG. 7, “average of medians” represents the entire section average of the extension length medians. Although the extension scale of the congested section 5 is set to three stages of “large,” “medium” and “small” in the present embodiment, it is needless to say that other granularities, for example, five stages or two stages, may be set.

Since the extension length of the congested section 5 is expressed in units of 10 m, the extension scale setting unit 13 performs processing of rounding up the first order of each of the values representing (entire section average of extension length medians−standard deviation) and (entire section average of extension length medians+standard deviation) such that the extension length serving as a determination criterion is represented in units of 10 m. Further, when the value of (entire section average of extension length medians−standard deviation) becomes equal to or less than 0, the value of (entire section average of extension length medians−standard deviation) is set to “10.”

The extension scale setting unit 13 compares the extension length of each congested section 5 classified into a determination division with an extension scale determination table 4 corresponding to the determination division, identifies an extension scale for each congested section 5, and sets the extension scale having the largest number as the extension scale of the congested section 5 in the determination division.

Specifically, the extension scale setting unit 13 classifies the extension scale of the extension length of each congested section 5 generated for each day of the week or each time zone to any of “large,” “medium,” and “small” with reference to the extension scale determination table 4, aggregates the number of classifications for each of “large,” “medium,” and “small”, and then determines the extension scale in the corresponding determination division as any of “large,” “medium,” and “small” by majority of the number of classifications. Although there may be two extension scales with the largest number of classifications, in a case in which both the number of cases in which the extension scale of a congested section 5 has been classified as “small” and the number of cases in which the extension scale has been classified as “medium” on Monday are 10 which is the largest, for example, the extension scale of the congested section 5 on Monday is set to “medium.” When the number of cases in which the extension scale has been classified as “small” and the number of cases in which the extension scale has been classified as “large” are identical and the largest, the extension scale of the congested section 5 on Monday is set to “medium”, and when the number of cases in which the extension scale has been classified as “medium” and the number of cases in which the extension scale has been classified as “large” are identical and the largest, the extension scale of the congested section 5 on Monday is set to “large.”

That is, the extension scale setting unit 13 sets the extension scale of the congested section 5 for each congested section 5 and for each determination division. The extension scale setting unit 13 stores the extension scale of the congested section 5 set for each congested section 5 and for each determination division in the storage device 16 as extension scale information 16D.

The extension scale setting unit 13 that sets the extension scale of the congested section 5 for each congested section 5 and for each determination division in this manner is an example of a setting unit.

When the division selection unit 14 receives prediction request information including a congested section 5 for which an extension length will be predicted, and a date and time, the division selection unit 14 identifies whether or not the extension scale of the congested section 5 designated by the prediction request information, that is, the congested section 5 for which an extension length will be predicted, has a deviation in the determination division using the extension scale information 16D set by the extension scale setting unit 13. Specifically, the division selection unit 14 identifies whether or not there is a deviation in at least one of determination divisions by days of the week, time zones, and working attributes with respect to the extension scale of the designated congested section 5.

When at least one determination division has a deviation, the division selection unit 14 selects a determination division used to predict the extension length of the congested section 5 according to a combination of determination divisions having a deviation of the extension scale.

For example, the division selection unit 14 selects the day-of-the-week division when there is a deviation in the day-of-the-week division, selects the working division when there is a deviation in the working division, and selects the time zone division when there is a deviation in the time zone division. Further, for example, the division selection unit 14 selects the day-of-the-week division and the time zone division when there is a deviation in the day-of-the-week division and the time zone division, and the division selection unit 14 selects the working division and the time zone division when there is a deviation in the working division and the time zone division. Since both the day-of-the-week division and the working division are divisions based on the day of the week, if there is a deviation in the day-of-the-week division and the working division, only a division having a higher degree of deviation may be regarded as having a deviation. When the day-of-the-week division and the working division have the same deviation, the working division is prioritized. Accordingly, it is possible to improve the accuracy of prediction of an extension length of a congested section 5 by increasing the number of pieces of data to be used for prediction.

As will be described later, the determination division selected by the division selection unit 14 is used to predict an extension length of a congested section 5 designated by prediction request information.

That is, the division selection unit 14 identifies whether or not there is a deviation in an extension scale of a designated congested section 5 within determination divisions using an extension scale for each congested section and for each determination division, obtained from the entire section average and standard deviation of medians of extension lengths of continuous identical congested sections 5 for which occurrence times have been classified into determination divisions by days of the week, working attributes, and time zones, and if there is a deviation in the extension scale of the designated congested section 5 within the determination divisions, selects a determination division used to predict an extension length of the congested section 5 according to a combination of the determination divisions in which there is a deviation in the extension scale.

The division selection unit 14 that selects a determination division used to predict an extension length of a congested section 5 in this manner is an example of a selection unit.

The extension length prediction unit 15 acquires each extension length corresponding to the designated congested section 5 classified according to the determination division selected by the division selection unit 14 from the congested section information 16C by divisions, and predicts an extension length of the designated congested section 5 at a designated date and time.

For example, it is assumed that the determination division selected by the division selection unit 14 is the day-of-the-week division and the date and time designated by prediction request information is Monday. In this case, the extension length prediction unit 15 outputs the average of extension lengths of all congested sections 5 classified into Monday as a prediction value for an extension length in the designated congested section 5 with reference to the day-of-the-week time zone division table 19A of the designated congested section 5 constituting the congested section information 16C by divisions. In the case of the example of the day-of-the-week time zone division table 19A shown in FIG. 5, the average value of the extension lengths of the congested sections 5 classified into the divisions from “M.” to “M23” becomes a predicted value for an extension length in the congested section 5 designated by the prediction request information.

Further, it is assumed that the determination division selected by the division selection unit 14 is the time zone division, and the date and time designated by the prediction request information is the date and time corresponding to the time zone after 18:00 and before 19:00, for example. In this case, the extension length prediction unit 15 outputs the average of extension lengths of all congested sections 5 classified into the time zone after 18:00 and before 19:00 as a prediction value for an extension length in the designated congested section 5 with reference to the day-of-the-week time zone division table 19A of the designated congested section 5 constituting the congested section information 16C by divisions. In the case of the example of the day-of-the-week time zone division table 19A shown in FIG. 5, the average value of extension lengths of congested sections 5 classified into divisions of “M18,” “Tu18,” “W18,” “Th18,” “F18,” “Sa18,” and “Su18” becomes a prediction value for an extension length in the congested section 5 designated by the prediction request information.

Further, it is assumed that the determination division selected by the division selection unit 14 is the day-of-the-week division and the time zone division, and the date and time designated by the prediction request information is a date and time corresponding to the time zone after 18:00 and before 19:00 of Monday, for example. In this case, the extension length prediction unit 15 outputs the average of extension lengths of all congested sections 5 classified into the time zone after 18:00 and before 19:00 on Monday as a prediction value for an extension length in the designated congested section 5 with reference to the day-of-the-week time zone division table 19A of the designated congested section 5 constituting the congested section information 16C by divisions. In the case of the example of the day-of-the-week time zone division table 19A shown in FIG. 5, the average value of extension lengths of congested sections 5 classified into the division of “M18” becomes a prediction value for an extension length in the congested section 5 designated by the prediction request information.

The extension length prediction unit 15 that predicts an extension length of the congested section 5 designated by the prediction request information in this manner is an example of a prediction unit.

Although the information processing apparatus 10 includes the storage device 16 in the present embodiment, the information processing apparatus 10 may not necessarily include the storage device 16. In this case, the information processing apparatus 10 may store and acquire various types of information with respect to the storage device 16 connected to a communication line via a communication unit 27 which will be described later, for example. Further, the information processing apparatus 10 may be separated into a first apparatus including the congestion classification unit 11, the congestion identity determination unit 12, and the extension scale setting unit 13, and a second apparatus including the division selection unit 14 and the extension length prediction unit 15. The first apparatus is an example of the information processing apparatus 10 that receives training data and outputs the congested section information 16C by divisions and the extension scale information 16D, and the second apparatus is an example of the information processing apparatus that receives the congested section information 16C by divisions, the extension scale information 16D, and prediction request information and outputs a prediction value for an extension length in the congested section 5 designated by the prediction request information.

Although an extension length in a congested section 5 is predicted in the above-described example, the present invention can also be applied to prediction of the congestion length of the congested section 5. If the congestion length is predicted, a vehicle driver can be notified of the occurrence of the congested section 5 without referring to past congestion information.

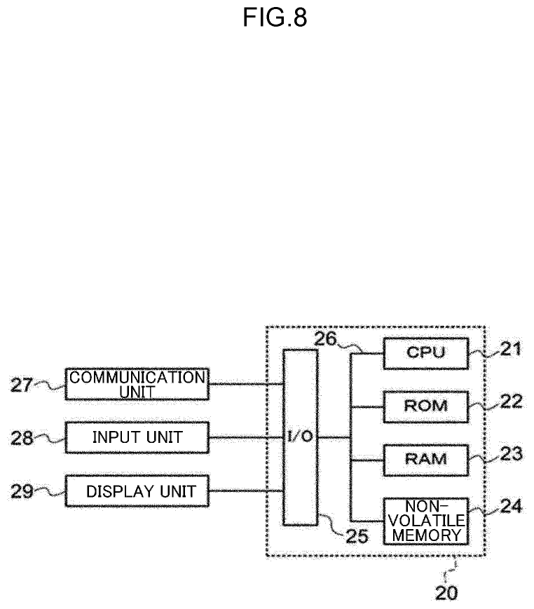

The information processing apparatus 10 having such functions is configured using a computer 20, for example. FIG. 8 is a diagram showing a configuration example of main parts of an electrical system of the computer 20 applied to the information processing apparatus 10.

The computer 20 includes a central processing unit (CPU) 21 for performing processing in each functional unit of the information processing apparatus 10 shown in FIG. 1. Further, the computer 20 includes a read only memory (ROM) 22 that stores an information processing program that causes the computer 20 to function as the information processing apparatus 10, and a random access memory (RAM) 23 that is used as a temporary work area for the CPU 21. Furthermore, the computer 20 includes a non-volatile memory 24 and an input/output interface (I/O) 25. The CPU 21, the ROM 22, the RAM 23, the non-volatile memory 24, and the I/O 25 are connected by a bus 26.

The non-volatile memory 24 is an example of a storage device 16 in which stored information is maintained even when power supplied to the non-volatile memory 24 is cut off, and for example, a semiconductor memory is used as the non-volatile memory 24, but a hard disk may be used. The non-volatile memory 24 does not necessarily have to be included in the computer 20, and for example, a portable non-volatile memory 24 that can be attached to or detached from the computer 20 may be used.

For example, the training data information 16A by directions, congested section information 16B, congested section information 16C by divisions, and extension scale information 16D are stored in the non-volatile memory 24.

The communication unit 27, an input unit 28, and a display unit 29 are connected to the I/O 25, for example.

The communication unit 27 is connected to a communication line such as the Internet and a local area network (LAN), for example, and includes a communication protocol for data communication with an external device (not shown) connected to the communication line in the same manner. The CPU 21 receives, for example, training data from an external device through the communication line connected to the communication unit 27. The communication line connected to the communication unit 27 may be wired or wireless.

The input unit 28 is a device that receives an instruction from a user and notifies the CPU 21 of details of the received instruction, and for example, a button, a touch panel, a keyboard, and a mouse may be used.

The display unit 29 is an example of a device that visually displays information processed by the CPU 21, and for example, a liquid crystal display or an organic electro luminescence (EL) display may be used.

When the information processing apparatus 10 receives an instruction of a user from an external device via the communication line and transmits information processed according to the instruction to the external device via the communication line, the input unit 28 and the display unit 29 do not necessarily have to be connected to the I/O 25.

Next, the operation of the information processing apparatus 10 of the present disclosure will be described.

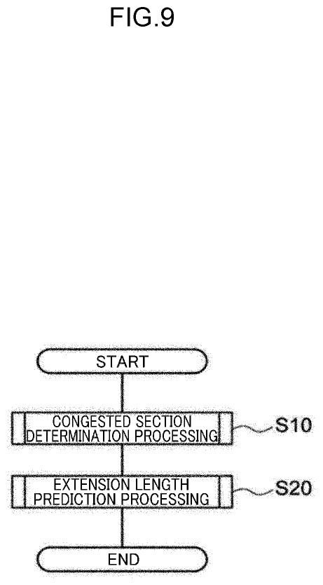

FIG. 9 is a flowchart showing an example of a flow of prediction processing executed by the CPU 21 of the information processing apparatus 10.

The information processing program that defines prediction processing is stored in, for example, the ROM 22 of the information processing apparatus 10 in advance. The CPU 21 of the information processing apparatus 10 reads the information processing program stored in the ROM 22 and executes prediction processing. It is assumed that training data is stored in advance in the non-volatile memory 24.

In step S10 of FIG. 9, the CPU 21 determines a congested section 3 from training data and executes congested section determination processing for generating congested section information 16B.

Next, in step S20, the CPU 21 executes extension length prediction processing for predicting an extension length of a congested section 3 designated by prediction request information at a designated date and time using the congested section information 16B generated in step S10, and ends prediction processing shown in FIG. 9.

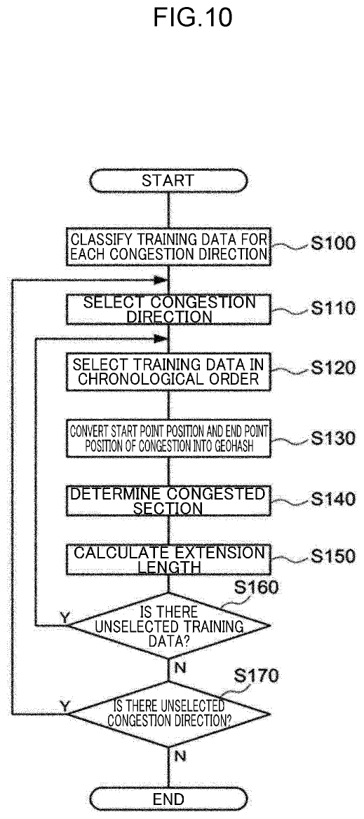

FIG. 10 is a flowchart showing an example of a flow of congested section determination processing executed in step S10 of prediction processing shown in FIG. 9.

In step S100 of FIG. 10, the CPU 21 acquires training data from the non-volatile memory 24 and classifies the acquired training data for each congestion direction. Accordingly, training data information 16A by directions is generated.

In step S110, the CPU 21 selects any one of the congestion directions to which the training data has been classified. The congestion direction selected in step S110 is called a selected congestion direction.

In step S120, the CPU 21 selects training data including the oldest time-series information among unselected training data classified into the selected congestion direction from the training data information 16A by directions. When there are a plurality of pieces of training data including time-series information representing the same date and time, a plurality of pieces of training data are selected. The training data selected in step S120 is called selected training data.

In step S130, the CPU 21 converts a start point position and an end point position of congestion included in the selected training data into a geohash 1.

In step S140, the CPU 21 determines which congested section 3 represented by each piece of selected training data is a congested section 5 constituting a continuous congested section 3 using the geohash 1 converted in step S130, and generates the congested section 5.

In step S150, the CPU 21 calculates the length of a congested section 5 for each congested section 5, classifies the congested section 5 for each congested section 5 which can be regarded as the same congestion, and compares the length of the congested section 5 for each identical congested section 5 with a length of the congested section 5 observed in the immediately preceding time series to calculate an extension length of each congested section 5 included in the identical congested sections 5. The CPU 21 associates the time series information included in the selected training data with the calculated extension length with respect to each congested section 5.

The length of a congested section 5 is obtained by referring to map data stored in advance in the non-volatile memory 24, for example, and calculating the distance along a road having the start point position and the end point position of the congested section 5 as end points. When there is no congested section 5 observed in the immediately preceding time series with respect to the generated congested section 5, the CPU 21 may set the extension length to “0.”

In step S160, the CPU 21 determines whether or not unselected training data is present in training data classified into the selected congestion direction, and when the unselected training data are present, the CPU 21 proceeds to step S120 and repeatedly execute steps S120 to S160. Accordingly, training data classified into the selected congestion direction is selected in chronological order, and thus time series information and an extension length are associated with each congested section 5 in the selected congestion direction.

On the other hand, when it is determined that unselected training data is not present in determination processing of the step S160, processing proceeds to step S170.

In step S170, the CPU 21 determines whether or not an unselected congestion direction is present in the congestion directions into which the training data are classified, and when the unselected congestion direction is present, the CPU 21 proceeds to step S110 and repeatedly executes steps S110 to S170. Accordingly, time-series information and an extension length are associated with each congested section 5 in all congestion directions, and congested section information 16B is generated.

Accordingly, congested section determination processing shown in FIG. 10 ends.

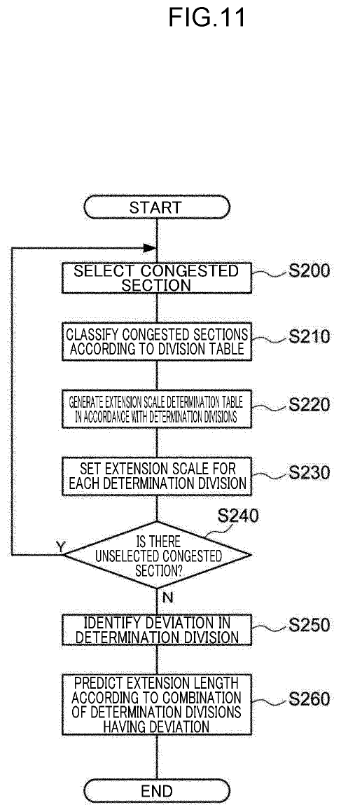

Meanwhile, FIG. 11 is a flowchart showing an example of a flow of extension length prediction processing executed in step S20 of prediction processing shown in FIG. 9.

In step S200 of FIG. 11, the CPU 21 selects identical congested sections 5 from the congested section information 16B. The congested sections 5 selected in step S200 is called selected congested sections 5.

In step S210, the CPU 21 classifies the selected congested sections 5 according to the division table 19 and generates congested section information 16 C by divisions.

In step S220, the CPU 21 generates an extension scale determination table 4 for each determination division using the entire section average of medians of extension lengths calculated from the extension lengths of the congested sections 5 classified into the determination divisions and the standard deviation of the medians of the extension lengths.

In step S230, the CPU 21 compares the extension length of each continuous congested section 5 among the congested sections 5 classified into the respective determination divisions with the extension scale determination table 4 in the determination divisions that are classification destinations of continuous congested sections 5, and determines an extension scale into which the extension length of the continuous congested section 5 is classified. Then, the CPU 21 sets an extension scale into which the largest number of extension lengths are classified as an extension scale of the congested section 5 in the corresponding determination division. When there are a plurality of extension scales into which the largest number of extension lengths are classified, the CPU 21 sets an extension scale of the congested section 5 in the determination division on the basis of a predetermined rule. For example, when the numbers of classifications of the extension scales of “small” and “medium” or “medium” and “large” are identical and the largest, the larger extension scale is adopted, and when the numbers of classifications of the extension scales of “large” and “small” are identical and the largest, “medium” which is the extension scale between “large” and “small” is adopted. That is, the CPU 21 sets the extension scale of a congested section 5 for each determination division with respect to the selected congested sections 5.

In step S240, the CPU 21 determines whether or not an unselected congested section 5 is present in the congested section information 16B, and when an unselected congested section 5 is present, the CPU 21 proceeds to step S200 and repeatedly executes steps S200 to S240. Accordingly, the extension scale of a congested section 5 can be obtained for each congested section 5 and each determination division based on training data.

In step S250, the CPU 21 identifies, for each determination division, whether or not there is a deviation in the extension scales of congested sections 5 that are extension length prediction targets, that is, prediction target congested sections 6.

Specifically, the CPU 21 determines that there is no deviation when all extension scales of the prediction target congested sections 6 in the determination divisions are identical, and determines that there is a deviation when at least one extension scale is different from the other extension scales. It should be noted that determination of the presence or absence of a deviation in determination divisions is not limited thereto, and it is needless to say that the determination may be performed by other methods.

In step S260, the CPU 21 selects a combination of determination divisions determined to have a deviation in step S250. When there is no determination division in which a deviation is present, the CPU 21 does not select any determination division. In this case, the extension lengths of congested sections 5 are predicted with reference to the congested sections 5 in the entire days of the week and the entire time zones.

The CPU 21 predicts the average of extension lengths of all congested sections 5 classified into a division corresponding to a designated date and time of the prediction target congested sections 6 as an extension length of the prediction target congested sections 6 at the designated date and time in the selected determination division. Then, the CPU 21 outputs the predicted extension length.

The CPU 21 may output the predicted extension length in any form if the user can recognize the extension length predicted by the information processing apparatus 10. For example, the CPU 21 may display the predicted extension length on the display unit 29 or may transmit the predicted extension length to an external device connected to a communication line via the communication unit 27. Further, the CPU 21 may print the predicted extension length on a sheet or may store the predicted extension length in the non-volatile memory 24. When the predicted extension length is equal to or greater than a predetermined length, it is also conceivable that a guide route in a road guidance navigation system is changed to a detour route that detours around the congested sections 5.

As above, extension length prediction processing shown in FIG. 11 ends, and simultaneously, prediction processing shown in FIG. 9 ends.

### Verification Results

Next, results of verification of an extension length of a congested section 5 predicted using the information processing apparatus 10 according to the present embodiment will be described.

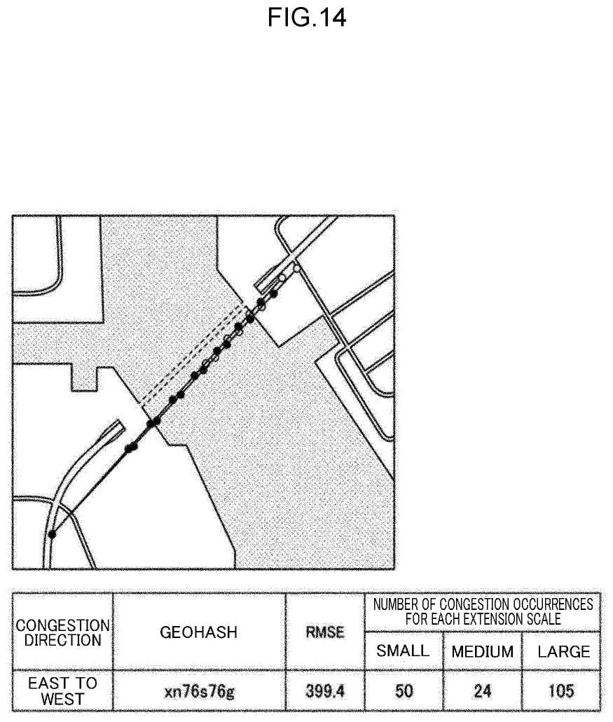

In order to perform this verification, training data from October 2019 to February 2021 in a predetermined verification area A was collected from congestion information of Japanese Road Traffic Information Center (JARTIC), and the extension length of a congested section 5 predicted using extension scale information 16D generated by changing the number of pieces of training data was compared with the actual extension length of the congested section 5. Congested sections 5 illustrated on the maps in FIGS. 14, 15, 16 and 17 are learning results obtained by learning using congested information acquired from JARTIC.

Specifically, RMSE in an extension length of a congested section 5 predicted using the extension scale information 16D, that is, a predicted extension length of the congested section 5, and the actual extension length of the congested section 5, that is, the actual extension length of the congested section 5, was calculated, and the prediction accuracy of the congested section 5 in the information processing apparatus 10 was evaluated.

RMSE is an abbreviation for “Root Mean Squared Error.” RMSE is an example of an accuracy evaluation index represented by a root mean square of a difference between the predicted extension length of the congested section 5 and the actual extension length of the congested section 5, and is calculated by Formula (1).

$$\begin{matrix}[ Math . 1 ] & \\ RMSE = \sqrt{\frac{1}{n} {\sum }_{k = 1}^{n} {( {f}_{k} - {y}_{k} )}^{2}} & ( 1 )\end{matrix}$$

In Formula (1), “n” represents the number of predicted extension lengths of the congested section 5, “k” represents the index of the number of predicted extension lengths, “fₖ” represents the k-th predicted extension length, and “yₖ” represents the k-th actual extension length.

As can be ascertained from Formula (1), RMSE is an accuracy evaluation index indicating that the prediction accuracy is higher as the value approaches 0.

When the information processing apparatus 10 classified training data representing congestion information of the verification area A by congestion directions and determined congested sections 5 using an 8-digit geohash 1, the data was classified into 63 congested sections 5.

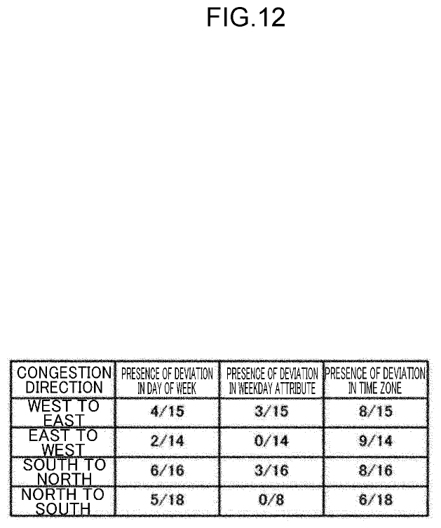

FIG. 12 is a diagram showing an example of the number of congested sections 5 in which a deviation is present in the extension tendency for each determination division with 63 congested sections 5 arranged by congestion directions.

The denominator of the numerical value in each column in FIG. 12 represents the number of congested sections 5 classified into the congestion direction corresponding to the row direction, and the numerator of the numerical value represents the number of congested sections 5 in which a deviation is detected in the determination division corresponding to the column direction in each congestion direction.

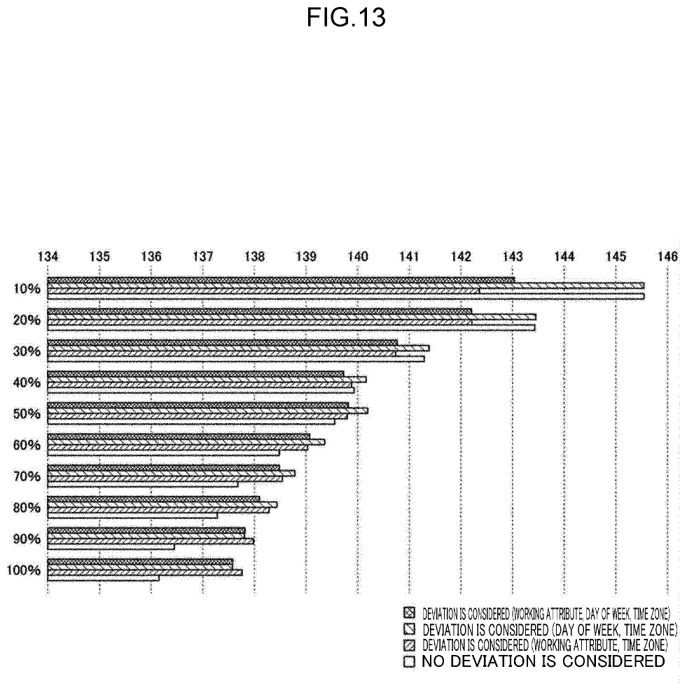

Further, FIG. 13 is a diagram showing an example of RMSE for each combination of determination divisions in consideration of a deviation in the extension tendency in a case in which extension lengths of congested sections 5 have been predicted while changing a use ratio of training data from 10% to 100% at an interval of 10%. RMSE when all the extension lengths of the congested sections 5 were set to “0” was “163.7245.” The unit of RMSE is meter.

According to the example of the RMSE shown in FIG. 13, it can be ascertained that the extension length prediction accuracy tends to increase in the case of prediction of extension lengths of congested sections 5 in consideration of a deviation in the extension tendency rather than in the case of prediction of the extension lengths of the congested sections 5 without considering a deviation in the extension tendency in the range in which the use ratio of training data used to predict the extension lengths of the congested sections 5 is 10% to 40% from older ones of the whole training data. That is, as the number of pieces of training data used to predict extension lengths of congested sections 5 decreases, the extension length prediction accuracy becomes higher when the extension lengths of the congested sections 5 are predicted in consideration of a deviation of the extension tendency.

Next, among 63 classified congested sections 5, features of congested sections 5 having a relatively low RMSE, that is, congested sections 5 with low prediction accuracy, and features of congested sections 5 having a relatively high RMSE, that is, congested sections 5 with high prediction accuracy are analyzed.

FIG. 14 is a diagram showing an example of analysis on a congested section 5 having the lowest extension length prediction accuracy among 63 classified congested sections 5. The congested section 5 to be analyzed shown in FIG. 14 is a congested section 5 from east to west, which is included in a geohash 1 with a symbol of “xn76s76g.” In addition, the numbers of congestion occurrences for respective extension scales in the congested section 5 to be analyzed shown in FIG. 14 are 50 for “small,” 24 for “medium,” and 105 for “large,” and RMSE is “399.4.”

In the congested section 5 to be analyzed in FIG. 14, an extension length exceeding 1000 m has been generated in a time zone after 18:00 and before 21:00, and thus the error in a predicted extension length of the congested section 5 in consideration of a deviation in the extension tendency for each day of the week and for each time zone is relatively large and the RMSE is considered to be high. That is, in the congested section 5 where congestion having an extension length exceeding 1000 m is likely to occur compared with other congested sections 5, the extension length prediction accuracy tends to decrease.

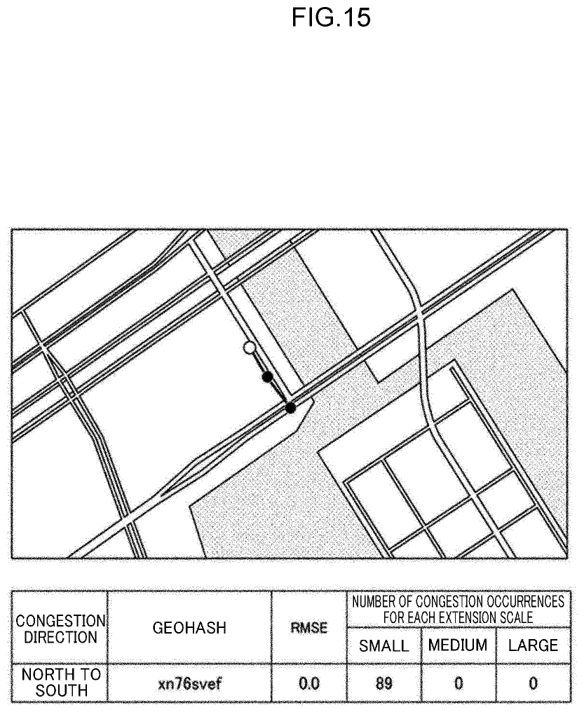

FIG. 15 is a diagram showing an example of analysis on a congested section 5 having the highest extension length prediction accuracy among the 63 classified congested sections 5.

The congested section 5 to be analyzed shown in FIG. 15 is a congested section 5 from north to south, which is included in a geohash 1 with a symbol of “xn76svef.” Further, the numbers of congestion occurrences for respective extension scales in the congested section 5 to be analyzed shown in FIG. 15 are 89 for “small,” 0 for “medium,” and 0 for “large,” and RMSE is “0.0.”

In the congested section 5 to be analyzed in FIG. 15, there the number of congestion occurrences is only 89, which is half or less of the number of congestion occurrences in the congested section 5 to be analyzed shown in FIG. 14. Furthermore, any extension length of the congested section 5 to be analyzed in FIG. 15 is “0” and all extension scales of the congested section 5 are classified into “small.” That is, as the number of congestion occurrences is smaller and the extension length of the congested section 5 is closer to 0, the extension length prediction accuracy tends to be higher.

Meanwhile, among congested sections 5, there is a congested section 5 having an extension length that is not “0” but having higher extension length prediction accuracy than that of the other congested sections 5.

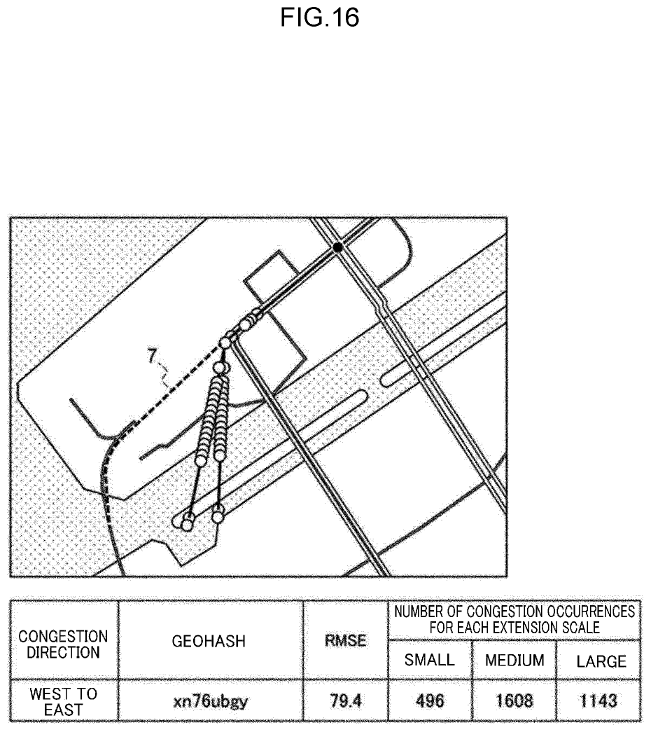

FIG. 16 is a diagram showing an example of analysis with respect to such a congested section 5. The congested section 5 to be analyzed shown in FIG. 16 is a congested section 5 from west to east, which is included in a geohash 1 with a symbol of “xn76ubgy.” Further, the numbers of congestion occurrences for respective extension scales in the congested section 5 to be analyzed shown in FIG. 16 are 496 for “small,” 1608 for “medium,” and 1143 for “large” and RMSE is “79.4.”

In the congested section 5 to be analyzed in FIG. 16, congestion has occurred in a time zone after 8:00 and before 18:00 on a weekday, the number of congestion occurrences is greater than those of the congested sections 5 to be analyzed shown in FIGS. 14 and 15, and there is an extension tendency in which the number of extension scale of “medium” is largest in the congested section 5. That is, congestion classified into the extension scale of “medium” easily occurs and there is a deviation in a time zone and day of the week in which extension occurs, and thus it is conceivable that the extension length prediction accuracy tends to increase in the congested section 5.

Although it is preferable that the congested section 5 shown in FIG. 16 be displayed along a dotted line 7 representing a road, the congested section 5 is displayed to be deviated from the dotted line 7 due to errors between the start positions and the end positions of congested sections 3 included in training data.

The results of verification of extension lengths of congested sections 5 predicted in the verification area A have been described. Next, results of verification of extension lengths of congested sections 5 predicted in a verification area B different from the verification area A will be described.

Although the training data collection period in the verification area B is the same as the training data collection period in the verification area A, the number of pieces of training data in the verification area B collected in the same period is about 6.7 times the number of pieces of training data in the verification area A. Further, the verification area B is an area where roads are more complicated than the verification area A.

When the information processing apparatus 10 classified training data representing congestion information of the verification area B by congestion directions and determined congested sections 5 using an 8-digit geohash 1, the data was classified into 204 congested sections 5. However, 25 branch points were present in the 204 classified congested sections 5.

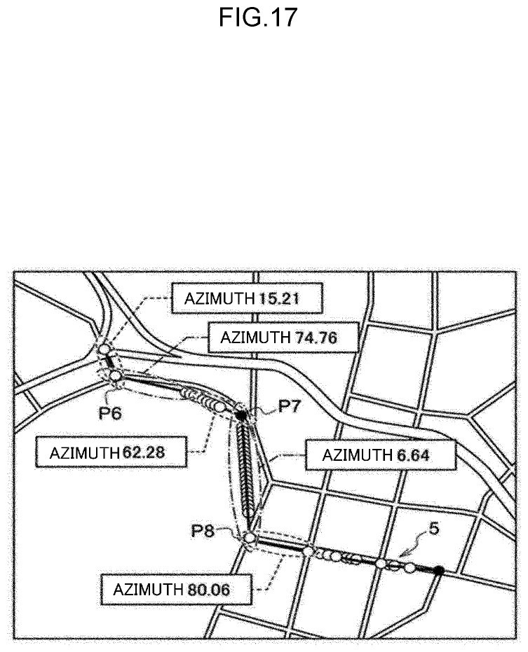

FIG. 17 is a diagram showing an example of congested sections 5 in the verification area B. The congested sections 5 shown in FIG. 17 include points P6, P7 and P8 corresponding to branch points.

When the azimuth of one of congested sections 3 adjacent to each other at the point P6 is 15.21 degrees, and the azimuth of the other congested section 3 is 74.76 degrees, the azimuth difference between the congested sections 3 is 59.55 degrees. When the azimuth of one of congested sections 3 adjacent to each other at the point P7 is 62.28 degrees, and the azimuth of the other congested section 3 is 6.64 degrees, the azimuth difference between the congested sections 3 is 55.64 degrees. Further, when the azimuth of one of congested sections 3 adjacent to each other at the point P8 is 6.64 degrees, and the azimuth of the other congested section 3 is 80.06 degrees, the azimuth difference between the congested sections 3 is 73.42 degrees.

Therefore, when a threshold value of an azimuth difference between congested sections 3 is set to, for example, 40 degrees, the congested section 5 shown in FIG. 17 is divided into three congested sections 5.

The threshold value of an azimuth difference between congested sections 3 may be set to an angle less than the minimum azimuth difference among azimuth differences between congested sections 3 constituting different congested sections 5, for example.

By dividing the congested section 5, the congested section 5 in the verification area B is classified into 235 congested sections 5.

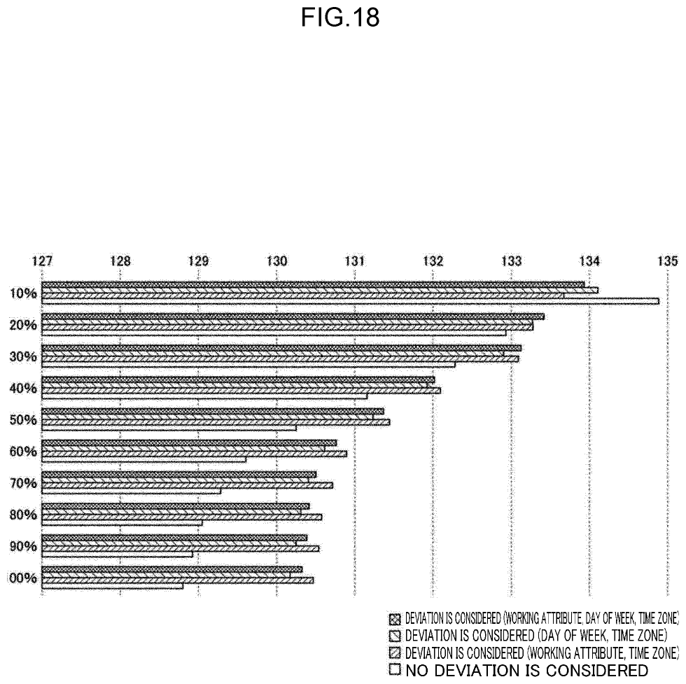

FIG. 18 is a diagram showing an example of RMSE for each combination of determination divisions in consideration of a deviation in the extension tendency in a case in which the extension lengths of congested sections 5 have been predicted while changing a use ratio of training data from 10% to 100% at an interval of 10% from older ones. When all the extension lengths of the congested sections 5 were set to “0,” RMSE was “179.8048.”

According to the example of the RMSE shown in FIG. 18, when the use ratio of the training data used to predict the extension lengths of the congested sections 5 is 10% from older ones of the whole training data, it is ascertained that the extension length prediction accuracy tends to increase in the case of prediction of the extension lengths of the congested sections 5 in consideration of a deviation in the extension tendency rather than in the case of prediction of the extension lengths of the congested sections 5 without considering a deviation in the extension tendency.

In the example of the RMSE in the verification area A shown in FIG. 13, it is ascertained that the extension length prediction accuracy tends to increase in the case of prediction of extension lengths of congested sections 5 in consideration of a deviation in the extension tendency rather than in the case of prediction of the extension lengths of the congested sections 5 without considering a deviation in the extension tendency in the range in which the use ratio of the training data used to predict the extension lengths of the congested sections 5 is 10% to 40% from older ones of the whole training data. This is a phenomenon derived from the fact that the number of pieces of training data collected in the verification area B is greater than the number of pieces of training data collected in the verification area A.

That is, the same tendency as the verification results in the verification area A in which the extension length prediction accuracy becomes higher when the extension lengths of the congested sections 5 have been predicted in consideration of a deviation in the extension tendency as the number of pieces of training data used to predict the extension lengths of the congested sections 5 is smaller also appears in the verification results of the verification area B.

Although one form of the information processing apparatus 10 has been described above, the disclosed form of the information processing apparatus 10 is an example, and the form of the information processing apparatus 10 is not limited to the scope described in the present embodiment. Various modifications or improvements can be added to the present embodiment without departing from the gist of the present disclosure, and the modified or improved forms are also included in the technical scope of the disclosure. For example, the order of prediction processing including congested section determination processing shown in FIG. 10 and extension length prediction processing shown in FIG. 11 may be changed without departing from the gist of the present disclosure.

Further, in the present disclosure, as an example, a form in which prediction processing is realized by software has been described. However, processing equivalent to the flowcharts shown in FIG. 10 and FIG. 11 may be implemented in, for example, an application specific integrated circuit (ASIC), a field programmable gate array (FPGA), or a programmable logic device (PLD), and processed by hardware. In this case, a processing speed can be increased as compared with a case in which prediction processing is realized by software.

In this manner, the CPU 21 of the information processing apparatus 10 may be replaced with a dedicated processor specialized for specific processing, such as an ASIC, an FPGA, a PLD, a graphics processing unit (GPU), and a floating point unit (FPU).

Prediction processing may be executed by a combination of two or more processors of the same type or different types, such as a plurality of CPUs 21 or a combination of the CPU 21 and an FPGA, in addition to a form in which the prediction processing is realized by one CPU 21.

Further, the prediction processing may be realized by cooperation of processors present at physically separate places, which are connected through the Internet, for example.

Further, although an example in which the information processing program is stored in the ROM 22 of the information processing apparatus 10 has been described in the present embodiment, the storage destination of the information processing program is not limited to the ROM 22. The information processing program of the present disclosure can also be provided in a form in which it is recorded on a storage medium readable by the computer 20. For example, the information processing program may also be provided in a form in which it is recorded on an optical disk such as a compact disk read only memory (CD-ROM) or a digital versatile disk read only memory (DVD-ROM). Further, the information processing program may also be provided in a form in which it is recorded on a portable semiconductor memory such as a Universal Serial Bus (USB) memory or a memory card.

The ROM 22, the non-volatile memory 24, a CD-ROM, a DVD-ROM, a USB, and a memory card are examples of a non-transitory storage medium.

Further, the information processing apparatus 10 may download the information processing program from an external device via the communication unit 27 and store the downloaded information processing program in the non-volatile memory 24, for example. In this case, the information processing apparatus 10 reads the information processing program downloaded from the external device and executes prediction processing.

All documents, patent applications, and technical standards described in the present specification are incorporated by reference in the present specification to the same extent as when each document, patent application, and technical standard is specifically and individually described to be incorporated by reference.

The following additional notes are disclosed in relation to the embodiments described above.

### Additional Note 1

An information processing apparatus including:
a memory; and
at least one processor connected to the memory,
wherein
the processor is configured to:
classify each congested section represented by training data including a start point position of congestion and an end point position of the congestion for each congestion direction represented by the start point position and the end point position;
recursively repeat processing of connecting adjacent congested sections in which the start point position and the end point position are within a predetermined range as a continuous integrated congested section until the start point position or the end point position of the adjacent congested sections disappears within the predetermined range, for each congested section classified for each congestion direction, to determine which congested sections constitute the integrated congested section; and
acquire the integrated congested section for each integrated congested section indicating the same congestion, classify, for each integrated congested section indicating the same congestion, the integrated congested section according to each determination division into which a congestion occurrence time is classified for each day of the week, each working attribute indicating whether a congestion occurrence time is a weekday or a holiday, and each time zone, and set an extension scale of the integrated congested section for each integrated congested section indicating the same congestion and for each determination division.

### Additional Note 2

An information processing apparatus including:
a memory; and
at least one processor connected to the memory,
wherein
the processor is configured to:
identify whether or not there is a deviation in an extension scale of a designated congested section for each determination division using an extension scale for each congested section obtained from an extension length for each of continuous identical congested sections for which an occurrence time has been classified into each determination division for each day of the week, each working attribute indicating whether a congestion occurrence time is a weekday or a holiday, each time zone, and for each determination division, and in a case in which there is a deviation in the extension scale of the designated congested section within the determination divisions, select the determination division to be used to predict an extension length of a congested section according to a combination of the determination divisions where there is a deviation in the extension scale; and
predict an extension length of the designated congested section at a designated date and time using the extension length of the designated congested section included in the selected determination division.

### Additional Note 3

An information processing apparatus including:
a memory; and
at least one processor connected to the memory,
wherein
the processor is configured to:
classify each congested section represented by training data including a start point position of congestion and an end point position of the congestion for each congestion direction represented by the start point position and the end point position;
recursively repeat processing of connecting adjacent congested sections in which the start point position and the end point position are within a predetermined range as a continuous integrated congested section until the start point position or the end point position of the adjacent congested sections disappears within the predetermined range, for each congested section classified for each congestion direction, to determine which congested sections constitute the integrated congested section; and
acquire the integrated congested section for each integrated congested section indicating the same congestion, classify, for each integrated congested section indicating the same congestion, the integrated congested section according to each determination division into which a congestion occurrence time is classified for each day of the week, each working attribute indicating whether a congestion occurrence time is a weekday or a holiday, and each time zone, and set an extension scale of the integrated congested section for each integrated congested section indicating the same congestion and for each determination division;
identify whether or not there is a deviation in an extension scale of a designated congested section within the determination divisions using the extension scale, and in a case in which there is a deviation in the extension scale of the designated congested section within the determination divisions, select the determination division to be used to predict an extension length of a congested section according to a combination of the determination divisions where there is a deviation in the extension scale; and
predict an extension length of the designated congested section at a designated date and time using the extension length of the designated congested section included in the selected determination division.

### Additional Note 4

An information processing program for causing a computer to execute processing of:
classify each congested section represented by training data including a start point position of congestion and an end point position of the congestion for each congestion direction represented by the start point position and the end point position;
recursively repeat processing of connecting adjacent congested sections in which the start point position and the end point position are within a predetermined range as a continuous integrated congested section until the start point position or the end point position of the adjacent congested sections disappears within the predetermined range, for each congested section classified for each congestion direction, to determine which congested sections constitute the integrated congested section; and
acquiring the integrated congested section for each integrated congested section indicating the same congestion, classifying, for each integrated congested section indicating the same congestion, the integrated congested section according to each determination division into which a congestion occurrence time is classified for each day of the week, each working attribute indicating whether a congestion occurrence time is a weekday or a holiday, and each time zone, and setting an extension scale of the integrated congested section for each integrated congested section indicating the same congestion and for each determination division.

### Additional Note 5

An information processing program for causing a computer to execute processing of:
identify whether or not there is a deviation in an extension scale of a designated congested section for each determination division using an extension scale for each congested section obtained from an extension length for each of continuous identical congested sections for which an occurrence time has been classified into each determination division for each day of the week, each working attribute indicating whether a congestion occurrence time is a weekday or a holiday, each time zone, and for each determination division, and in a case in which there is a deviation in the extension scale of the designated congested section within the determination divisions, select the determination division to be used to predict an extension length of a congested section according to a combination of the determination divisions where there is a deviation in the extension scale; and
predicting an extension length of the designated congested section at a designated date and time using the extension length of the designated congested section included in the selected determination division.

### Additional Note 6

A non-transitory storage medium storing a program executable by a computer such that prediction processing is executed,
wherein the prediction processing comprises:
a classification step of classifying each congested section represented by training data including a start point position of congestion and an end point position of the congestion for each congestion direction represented by the start point position and the end point position;
a determination step of recursively repeating processing of connecting adjacent congested sections in which the start point position and the end point position are within a predetermined range as a continuous integrated congested section until the start point position or the end point position of the adjacent congested sections disappears within the predetermined range, for each congested section classified for each congestion direction, to determine which congested sections constitute the integrated congested section;
a setting step of classifying, for each integrated congested section indicating the same congestion, the integrated congested section according to each determination division into which a congestion occurrence time is classified for each day of the week, each working attribute indicating whether a congestion occurrence time is a weekday or a holiday, and each time zone, and setting an extension scale of the integrated congested section for each integrated congested section indicating the same congestion and for each determination division;
a selection step of identifying whether or not there is a deviation in an extension scale of a designated congested section within the determination divisions using the extension scale, and in a case in which there is a deviation in the extension scale of the designated congested section within the determination divisions, selecting the determination division to be used to predict an extension length of a congested section according to a combination of the determination divisions where there is a deviation in the extension scale; and
a prediction step of predicting an extension length of the designated congested section at a designated date and time using the extension length of the designated congested section included in the selected determination division.

1. An information processing apparatus comprising:
a memory; and
at least one processor coupled to the memory, the at least one processor being configured to:
recursively repeat processing of connecting congested sections occurring intermittently in which a start point position and an end point position of a congestion are within a predetermined range as a continuous integrated congested section until a start point position or an end point position of a congested section disappears within the predetermined range, for each congested section classified for each congestion direction, to determine which congested sections constitute the integrated congested section.

2. The information processing apparatus according to claim 1, wherein the at least one processor,
in a case in which an azimuth difference between congested sections branched from a connection point in a continuous integrated congested section composed of a plurality of congested sections is equal to or greater than a predetermined angle, divides the integrated congested section into two different integrated congested sections at a connection point of congested sections in which the azimuth difference is equal to or greater than the predetermined angle.

3. An information processing apparatus comprising:
a memory; and
at least one processor coupled to the memory, the at least one processor being configured to:
identify whether or not there is a deviation in an extension scale of a designated congested section for each determination division using an extension scale for each congested section obtained from an extension length for each of continuous identical congested sections for which an occurrence time has been classified into each determination division for each day of the week, each working attribute indicating whether a congestion occurrence time is a weekday or a holiday, and each time zone, and for each determination division, and when there is a deviation in the extension scale of the designated congested section within the determination divisions, select the determination division to be used to predict an extension length of a congested section according to a combination of the determination divisions where there is a deviation in the extension scale; and
predict an extension length of the designated congested section at a designated date and time using the extension length of the designated congested section included in the selected determination division.

4. The information processing apparatus according to claim 3, wherein at least one processor predicts an extension length of the designated congested section at the designated date and time using an extension length of the designated congested section included in a combination of the determination divisions corresponding to the designated date and time among all combinations of the determination divisions in which there is a deviation in the extension scale of the designated congested section.

5. A non-transitory storage medium storing a program for causing a computer to function as of the information processing apparatus according to claim 1.

6. An information processing method in an information processing apparatus, the information processing method comprising:
a classification step which classifies each congested section represented by training data including a start point position of a congestion and an end point position of the congestion for each congestion direction represented by the start point position and the end point position;
a determination step which recursively repeats processing of connecting congested sections in which the start point position and the end point position are within a predetermined range as a continuous integrated congested section until the start point position or the end point position of the congested section disappears in the predetermined range, for each congested section classified for each congestion direction, to determine which congested sections constitute the integrated congested section;
a setting step which classifies, for each integrated congested section indicating the same congestion, the integrated congested section according to each determination division into which a congestion occurrence time is classified for each day of the week, each working attribute indicating whether a congestion occurrence time is a weekday or a holiday, and each time zone, and sets an extension scale of the integrated congested section for each integrated congested section indicating the same congestion and for each determination division;
a selection step which identifies whether or not there is a deviation in an extension scale of a designated congested section within the determination divisions using the extension scale, and when there is a deviation in the extension scale of the designated congested section within the determination divisions, selects the determination division to be used to predict an extension length of a congested section according to a combination of the determination divisions where there is a deviation in the extension scale; and
a prediction step which predicts an extension length of the designated congested section at a designated date and time using the extension length of the designated congested section included in the selected determination division.

7. The information processing apparatus according to claim 1, wherein the at least one processor determines the congested sections constituting the integrated congested section without limiting a position of a start point of the integrated congested section to a specific position on a road.

8. The information processing apparatus according to claim 2, wherein the at least one processor divides the integrated congested section in which an azimuth difference between congested sections branching from a connection point in the integrated congested section is equal to or greater than the predetermined angle into a first integrated congested section passing through the connection point in the integrated congested section and a second integrated congested section starting from the connection point in the integrated congested section.
